(19) United States
(12) Patent Application Publication
(10) Pub. No.: US 2009/0152055 A1
(43) Pub. Date: Jun. 18, 2009

(54) Wheel motor cooling

(76) Inventor: Isaiah Watas Cox, Baltomore, MD (US)

Correspondence Address: Borealis Technical Limited, 23545 NW Skyline Blvd, North Plains, OR, 97133-9204, US

(21) Appl. No.: 12/316,957

(22) Filed: Dec. 17, 2008

Related U.S. Application Data
(60) Provisional application No. 61/008,283, filed on Dec. 18, 2007.

(51) Int. Cl. F16D 55/02

(52) U.S. Cl. 188/71.6

(57) ABSTRACT

The present invention provides a means for cooling the brakes of under-carriage wheels by disengaging and spinning the motor used to provide traction on landing, thereby providing fan cooling of the brakes.

### CROSS-REFERENCE TO RELATED APPLICATIONS

This patent application claims the benefit of U.S. provisional patent application No. 61/008,283 filed 18 Dec. 2007 which application is included herein in its entirety by reference.

### BACKGROUND OF THE INVENTION

Methods and apparatus for cooling vehicle motors are disclosed in the art.

WO 2007107489 to Moreau et. al. discloses a fan propeller for cooling a vehicle engine or motor, placed in front of or behind the engine cooling radiator. The invention is concerned with reducing weight and improving performance by having specific thickness profile. To this end the fan propeller comprises a hub and blades extending radially outwards from the hub, the blades having a flattened cross-section with an aircraft wing profile including a leading edge and a trailing edge between which is defined a chord. The blade has a relative thickness up to a maximum value (Emax) in the first quarter of the chord length starting from the leading edge, the relative thickness being defined by the ratio between the thickness of the blade and the length of the chord.

DE 102005003853 to Geiger discloses a gas turbine comprising a compressor, a combustion chamber, and a turbine having at least one generator for generating electrical energy. After switching off the gas turbine for a period of time, each generator is used as an engine to drive the rotor of respective turbine, causing uniform cooling to the rotor.

DE 4235815 to Mader et. al. discloses a control system in which each wheel on the undercarriage has an air turbine and a brake unit. The output of a compressor can be connected to the turbines via a compressed air line. The air line is in connection, on the wheel side, with the input of a control valve. This has a first output connected to the turbine and a second output connected to the brake. It also has an actuator connected to a control unit. An air powered turbo unit provides the compressed air. The control unit is connected to pressure sensors on the wheel side and the turbo side and is connected to temperature sensors on the wheel side. The invention increases servicing intervals of brake system and increases life and reliability, relieves pilot during landing, and is a light, simple, low power system.

Electrically-powered motors for rendering an aircraft self-propelled on the ground without the need for turbine thrust have become very desirable as they offer the possibility of lower carbon dioxide emissions, more efficient fuel usage, and reduced noise levels. However, a problem with large aircraft is how to dissipate heat generated by braking, and having additional hardware in the main gear may adversely impact the cooling of the wheels, brakes and motors after a landing event.

Motors providing high torque at low speeds are known in the art. Specifically, such motors are known that are designed for the purpose of propelling aircraft on the ground.

WO05112584 to Edelson discloses a motor-generator machine comprising a slotless AC induction motor. The motor disclosed therein is an AC induction machine comprising an external electrical member attached to a supporting frame and an internal electrical member attached to a supporting core; one or both supports are slotless, and the electrical member attached thereto comprises a number of surface mounted conductor bars separated from one another by suitable insulation. An airgap features between the magnetic portions of core and frame. Electrical members perform the usual functions of rotor and stator but are not limited in position by the present invention to either role. The stator comprises at least three different electrical phases supplied with electrical power by an inverter. The rotor has a standard winding configuration, and the rotor support permits axial rotation.

WO2006002207 to Edelson discloses a motor-generator machine comprising a high phase order AC machine with short pitch winding. Disclosed therein is a high phase order alternating current rotating machine having an inverter drive that provides more than three phases of drive waveform of harmonic order H, and characterized in that the windings of the machine have a pitch of less than 180 rotational degrees. Preferably the windings are connected together in a mesh, star or delta connection. The disclosure is further directed to selection of a winding pitch that yields a different chording factor for different harmonics. The aim is to select a chording factor that is optimal for the desired harmonics.

Disclosed in WO2006/065988 to Edelson is a motor-generator machine comprising stator coils wound around the inside and outside of a stator, i.e. toroidally wound. The machine may be used with a dual rotor combination, so that both the inside and outside of the stator may be active. Even order drive harmonics may be used, if the pitch factor for the windings permits them. In a preferred embodiment, each of the coils is driven by a unique, dedicated drive phase. However, if a number of coils have the same phase angle as one another, and are positioned on the stator in different poles, these may alternatively be connected together to be driven by the same drive phase. In a preferred embodiment, the coils are connected to be able to operate with 2 poles, or four poles, under H=1 where H is the harmonic order of the drive waveform. The coils may be connected together in series, parallel, or anti-parallel.

In U.S. patent application Ser. No. 11/403,402, filed Apr. 12, 2006, a motor-generator machine is disclosed comprising a polyphase electric motor which is preferably connected to drive systems via mesh connections to provide variable V/Hz ratios. The motor-generator machine disclosed therein comprises an axle; a hub rotatably mounted on said axle; an electrical induction motor comprising a rotor and a stator; and an inverter electrically connected to said stator; wherein one of said rotor or stator is attached to said hub and the other of said rotor or stator is attached to said axle. Such a machine may be located inside a vehicle drive wheel, and allows a drive motor to provide the necessary torque with reasonable system mass.

International Appl. No. PCT/US2006/12483, filed Apr. 5, 2006, discloses a motor-generator machine comprising an induction and switched reluctance motor designed to operate as a reluctance machine at low speeds and an inductance machine at high speeds. The motor drive provides more than three different phases and is capable of synthesizing different harmonics. As an example, the motor may be wound with seven different phases, and the drive may be capable of supplying fundamental, third and fifth harmonic. The stator windings are preferably connected with a mesh connection. The system is particularly suitable for a high phase order induction machine drive systems of the type disclosed in U.S. Pat. Nos. 6,657,334 and 6,831,430. The rotor, in combination with the stator, is designed with a particular structure that reacts to a magnetic field configuration generated by one drive waveform harmonic. The reaction to this harmonic by the rotor structure produces a reluctance torque that rotates the rotor. For a different harmonic drive waveform, a different magnetic field configuration is produced, for which the rotor structure defines that substantially negligible reluctance torque is produced. However, this magnetic field configuration induces substantial rotor currents in the rotor windings, and the currents produce induction based torque to rotate the rotor.

PCT application no. WO 2007/103266-A2 to Edelson, filed 2 Mar. 2007, discloses a motor comprising: a fixed member comprising a magnetic core and magnetic windings, having an internal cavity; a driven member inside said fixed member, comprising magnetically conductive materials; said driven member being situated inside, and able to move within, said fixed member, wherein magnetic normal force is induced in said fixed member periodically, whereby said driven member is periodically moved by magnetic force with respect to said fixed member, whereby periodic motion is produced.

### BRIEF SUMMARY OF THE INVENTION

An apparatus for cooling undercarriage components of a self-propelled aircraft undercarriage wheel comprising: at least one self-propelled aircraft undercarriage wheel; at least one drive means for propelling said undercarriage wheel; and preferably at least one wheel brake; whereby said drive means acts as a fan to cool said undercarriage components, which may be brakes, wheels, tire beads, drive means or any other undercarriage components. Said undercarriage wheel may be a nosewheel, main gear or any or several or all wheels in an aircraft.

A technical advantage of this approach is that any reduced heat flow that comes about as a result of a motor being located adjacent to the wheel is overcome by running the disengaged motor as a fan cooler. This is achieved without additional added weight or an increased space requirement in the under-carriage bay.

A further technical advantage of this approach is that with the cooling means in operation, the brake-cooling rate will be considerably increased and the turn-round time will be reduced.

A further technical advantage is that the peak temperatures of the tire beads and hydraulic fluid will be reduced below critical values.

### BRIEF DESCRIPTION OF THE SEVERAL VIEWS OF THE DRAWING

The present invention and its technical advantages can be better understood with reference to the following drawings in which:

FIG. 1 shows the first embodiment of the invention with fan blades.

FIG. 2 shows the first embodiment of the invention with air tunnels.

### DETAILED DESCRIPTION OF THE INVENTION

An apparatus for cooling undercarriage components of a self-propelled aircraft undercarriage wheel comprising: at least one self-propelled aircraft undercarriage wheel; at least one drive means for propelling said undercarriage wheel; and preferably at least one wheel brake; whereby said drive means acts as a fan to cool said undercarriage components, which may be brakes, wheels, tire beads, drive means or any other undercarriage components.

Said undercarriage wheel may be a nosewheel, main gear, or any or several or all wheels in any aircraft. Said drive means is preferably one of the motors disclosed in the background section of this patent, since these are designed to have properties suitable for driving an aircraft. Said drive means may also be any high phase order, mesh connected electric induction motor. An advantage of this is that such motors are lightweight, and provide high torque at low speed, as is needed to pull an aircraft. Alternatively, said drive means may be an induction motor, switched reluctance motor, permanent magnet motor or other drive means.

Said wheel brake may be a disc brake, drum brake, hydraulically activated brake, electrically activated brake, or any brake known in the art.

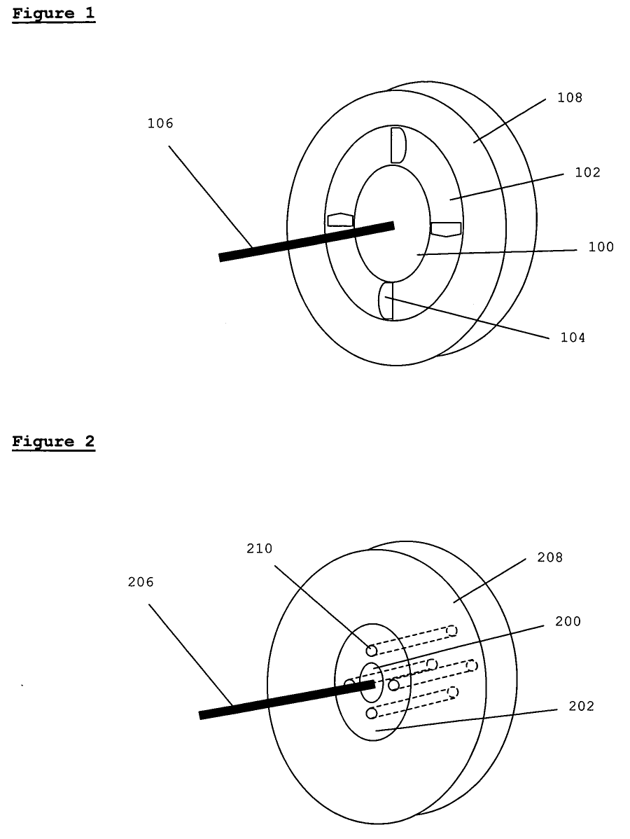

In a first embodiment of the present invention, shown in FIG. 1, said drive means comprises a rotor 102 and a stator 100, mounted on undercarriage wheel 108 and rotationally mounted on axle 106. When said rotor is spun, cooling automatically occurs. Said rotor may be shaped like a fan with fan blades 104 (thus having an integral fan), such that air is circulated near said brakes. Alternatively a fan may be mounted on said rotor. Alternatively or additionally, said rotor may comprise holes or tunnels 210 as shown in FIG. 2, such that air from a cooler location, such as the atmosphere adjacent any outer face of the undercarriage assembly, is brought close to said brakes and circulated around said brakes when said rotor spins. FIG. 2 also shows stator 200 and rotor 202 mounted on undercarriage wheel 208 and axle 206. Furthermore, air pipes or heat pipes may carry air from a cooler location such as an air conditioning unit or other cool location, and bring said air close to said brakes in order that more cooling occurs when the air is circulated.

Said holes or tunnels may be provided specifically for cooling or may be provided to perform other functions such as providing a space for a valve stem of a tire or in other ways enabling access to the undercarriage equipment for maintenance. It should be noted that the motor components themselves preferably remain sealed from air, water, dust or other atmospheric conditions while the external shape of the rotor performs cooling. Since even a sealed motor radiates heat in operation, cooling is still necessary.

Said rotor may be disengaged from said wheel for spinning and the apparatus may further comprise engagement/disengagement means for this purpose, as well as sensing means and control means for spinning the rotor as described in the second embodiment below.

The figures are given as examples only and are not intended to be limiting. It will be readily understood that many other arrangements and configurations will be possible that will be covered by the scope of this patent, for example, a rotor inside a stator, multiple stators or rotors, eccentric rotors, etc.

The apparatus may further comprise gears or gear trains as known in the art, or other means for modifying or adapting the speed and/or torque of the drive means with respect to the wheel or cooling means. This includes the use of gears or gear trains, torque converters, planetary gear transmissions, cycloidal reducers, clutches and other known speed and torque transmission means. Said gear, gear train or other transmission means may be separate from or integral to the motor.

In a second embodiment, said rotor can be engaged and disengaged from cooling apparatus. Said cooling apparatus is preferably a fan with fan blades directing air towards the brakes. Holes, tunnels or pipes may direct cooler air to the brakes as described in the previous embodiment. When said rotor is engaged with the fan, it spins the fan and cools the brakes. Said cooling means may be any other means for cooling an undercarriage component.

The apparatus preferably comprises fan engagement/disengagement means for engaging and disengaging the cooling means (from/with the wheel and/or the drive means), and drive means controls for turning on the drive means and thus spinning the rotor. Thus, during descent, said rotor might be disengaged from said cooling means, and upon landing, the rotor would be engaged with the cooling means ancomponents have cooled, the rotor may be stopped and disengaged. The rotor can then be engaged with the undercarriage drive means and used to drive the aircraft on the ground. Alternatively, said rotor may be engaged with said cooling means during landing but not spun. These sequences of events are given as examples and any other sequence of events in the spirit of the invention may also be used. For example, said cooling means may operate at the same time as the drive means.

Said engagement/disengagement means may comprise a clutch system or any other means for engaging or disengaging known in the art.

The rotor and cooling means may be engaged and disengaged manually by use of an engagement control which may be a push button, switch or the like, in the cockpit, at the gate, or at another useful location. Alternatively or additionally, sensing means may be disposed on the aircraft for sensing when the aircraft is descending, grounded, braking after landing, stopped after landing, the brakes or other components are sufficiently cooled, or any combination of the above. These sensing means may include altitude sensors, temperature sensors, or speed sensors as known in the art or any sensors known in the art that will work for this purpose. The sensing means may be used to sense when the rotor should be engaged with the cooling means and spun, and to automatically do so. For example and without limitation, an altitude sensor may sense that the aircraft is grounded, a speed sensor may sense that the aircraft is stopped, and after this combination of events, a signal may be sent using a logic control to the engagement/disengagement means to engage the rotor automatically, and a signal to the drive means controls to turn on the drive means and spin the rotor. Later a temperature sensor may detect that the brakes have cooled sufficiently, and send a signal via a logic control to the engagement/disengagement means to disengage the rotor automatically, and a signal to the drive means controls to turn off the drive means.

Alternatively, the sensing means may display a light, symbol or other status display to the pilot, ground staff or other aircraft controller to inform them of the status of the aircraft in order that they can manually engage/disengage the rotor and the cooling means and spin or stop them as required.

All other features are as in the first embodiment.

1. An apparatus for cooling self-propelled aircraft undercarriage components, comprising:
at least one self-propelled aircraft undercarriage wheel;
at least one drive means for propelling said undercarriage wheel; said drive means comprising a rotor and a stator;
whereby said drive means acts as a cooling means to cool said undercarriage components.

2. The apparatus of claim 1 wherein said undercarriage components comprise at least one wheel brake.

3. The apparatus of claim.1 wherein said drive means comprises one selected from the list comprising: electric induction motor, high phase order electric induction motor, permanent magnet motor, switched reluctance motor.

4. The apparatus of claim 1 wherein said drive means comprises a rotor, wherein the spinning of said rotor causes cooling.

5. The apparatus of claim 4, said rotor comprising built-in fan blades.

6. The apparatus of claim 4, said rotor comprising holes or tunnels.

7. The apparatus of claim 4, further comprising at least one selected from the list comprising air pipe; heat pipe.

8. The apparatus of claim 4.wherein said drive means comprises at least one separate fan component mounted on said rotor, wherein said fan spins with said rotor whereby said at least one fan acts as cooling means.

9. The apparatus of claim 4 further comprising:
a separate fan component;
fan engagement/disengagement means;
wherein said fan can be disengaged from said wheel and engaged with said rotor for cooling, disengaged from said rotor when cooling is not required, and engaged with said wheel for aircraft propulsion.

10. The apparatus of claim 9 further comprising sensing means, wherein said fan is automatically disengaged during landing.

11. The apparatus of claim 9 further comprising sensing means, wherein said fan is automatically engaged at a particular time after landing.

12. The apparatus of claim 9 further comprising at least one selected from the list comprising:
a logic control;
a drive means control;
an engagement control;
a status display.

13. A method for cooling self-propelled aircraft undercarriage components, said undercarriage having drive means having a rotor and a stator, the method comprising spinning said rotor; whereby cooling of the undercarriage components occurs.
